(19) United States
(12) Patent Application Publication
(10) Pub. No.: US 2025/0361622 A1
(43) Pub. Date: Nov. 27, 2025

(54) FORMATION OF ALLOYS ON 2D AND 3D ELECTRICALLY CONDUCTING SURFACES UTILIZING GALVANIC DISPLACEMENT

(71) Applicant: COLORADO STATE UNIVERSITY RESEARCH FOUNDATION, Fort Collins, CO (US)

(72) Inventors: Jessica R. Gallawa, Fort Collins, CO (US); Amy L. Prieto, Fort Collins, CO (US)

(73) Assignee: COLORADO STATE UNIVERSITY RESEARCH FOUNDATION, Fort Collins, CO (US)

(21) Appl. No.: 19/219,840

(22) Filed: May 27, 2025

Related U.S. Application Data
(60) Provisional application No. 63/652,034, filed on May 26, 2024.

(51) Int. Cl. C23C 18/54; C25D 3/32; C25D 5/48; C25D 21/08; C25D 21/12; H01M 4/02; H01M 4/04; H01M 4/1395; H01M 4/38

(52) U.S. Cl. CPC C23C 18/54; C25D 3/32; C25D 5/48; C25D 21/08; C25D 21/12; H01M 4/0452; H01M 4/0461; H01M 4/1395; H01M 4/387; H01M 2004/027

(57) ABSTRACT

Methods for utilizing galvanic displacement for synthesizing alloys, such as SnSb and Cu₂Sb on 2D and 3D structures with control over morphology and composition, by incorporating Sb into a Sn-coated 2D film or 3D foam, or incorporating Sb into a copper 2D film or 3D foam, respectively, are described. Additionally, the effect of changes in SnSb morphology on the lifetimes and rate capabilities of films and foams synthesized by galvanic displacement and used as anodes for sodium-ion batteries were investigated.

### CROSS-REFERENCE TO RELATED APPLICATIONS

The present application claims the benefit of U.S. Provisional Patent Application No. 63/652,034 for “Formation of SnSb on 2D and 3D Surfaces Using Galvanic Displacement” which was filed on May 26, 2024, the entire content of which Patent Application is hereby specifically incorporated by reference herein for all that it discloses and teaches.

### BACKGROUND

Renewable energy sources, such as wind and solar are intermittent, and energy storage systems must be implemented to redistribute energy as needed to supply the electrical grid. Rechargeable Lithium-ion batteries (LIBs) have good power, energy density, and long lifespans. Sodium-ion batteries (NIBs) have the same working principle as LIBs but utilize cheaper, greater earth-abundant materials. However, the materials used in LIBs do not directly translate to NIBs since the atomic size of sodium inhibits diffusion, accelerates decomposition by fracturing electrode materials, and, in general, NIBs have a much lower lifetime than LIBs.

Promising anode materials for NIBs include SnSb deposited on substrates since these have high theoretical capacities with sodium. 3-Dimensional architectures help accommodate volume expansion-related issues (fracturing and delamination) by maximizing available surface area, while increasing power density. Common methods for fabricating 3D electrodes include electrodeposition, chemical vapor deposition, electrospinning, and additive manufacturing. Electrodeposition is low-cost and can be cast without carbonaceous additives. Achieving a homogeneous surface coverage on a 3D structure with any of these methods alone is challenging, and doing so with compositional control during alloy deposition can be more difficult.

### SUMMARY

In accordance with the purposes of embodiments of the present invention, as embodied and broadly described herein, an embodiment of the method for forming a film or coating of SnSb onto a 2-dimensional substrate, hereof, includes: preparing a solution having a chosen concentration of tin (II) chloride dihydrate in ethaline; electrodepositing a film of tin from the tin (II) chloride dihydrate solution onto a metal substrate; preparing a second solution having a chosen concentration of antimony (III) chloride in ethaline; and exposing the electrodeposited film to the second solution for a chosen time and at a selected temperature; whereby electrodeposited tin in the film is replaced by antimony by galvanic displacement, thereby generating a chosen quantity of SnSb on the film.

In another aspect of embodiments of the present invention, and in accordance with their purposes, an embodiment of the method for forming a SnSb film or coating onto a 3-dimensional porous substrate, hereof, includes: preparing an aqueous solution having a chosen concentration of tin (II) chloride dihydrate, HCl, and Sodium Citrate; electrodepositing a film of tin from the aqueous solution of tin (II) chloride dihydrate, HCl and Sodium Citrate onto a 3-dimensional metal substrate for a chosen time at a selected voltage range; preparing a second solution of having a chosen concentration of antimony (III) chloride in ethaline; and exposing the 3-dimensional metal substrate to the second solution for a second chosen time and at a second chosen temperature; whereby electrodeposited tin on the 3-dimensional metal substrate is replaced by antimony by galvanic displacement, thereby generating a chosen quantity of SnSb on the 3-dimensional metal substrate.

In yet another aspect of embodiments of the present invention, and in accordance with their purposes, an embodiment of the method for forming a Cu₂Sb film or coating into a 2-dimensional or 3-dimensional porous copper or solid copper substrate, hereof, includes: preparing a solution of SbCl₃ in ethaline at 80° C.; and submersing the copper substrate in the solution for a chosen period.

Benefits and advantages of the present invention include, but are not limited to, providing a method for utilizing galvanic displacement to synthesize SnSb or Cu₂Sb on 2D and 3D structures with control over morphology and composition, by incorporating Sb onto a previously generated Sn-coated 2D film or 3D foam, or by incorporating Sb into a copper 2D film or 3D foam or solid substrate. Such films and foams can be used as anodes for Lithium-ion and Sodium-ion batteries.

### BRIEF DESCRIPTION OF THE DRAWINGS

The accompanying drawings, which are incorporated in and form a part of the specification, illustrate the embodiments of the present invention and, together with the description, serve to explain the principles of the invention. In the drawings:

FIG. 1 illustrates X-ray diffraction patterns of Sn—Sb films prepared by galvanic displacement (Sn film submerged in an ethaline solution having 50 mM SbCl₃ for 2 min.) at different temperatures, at room temperature (25° C.), 40° C., 60° C., and 80° C., showing that as the temperature is increased, the conversion from Sn to Sb increases, with the crystalline Sn phase disappearing at higher temperatures and a crystalline phase of SnSb forming.

FIG. 2 X-ray illustrates diffraction patterns of Sn—Sb thin films prepared by galvanic displacement with different immersion times (0 s, pristine, to 120 s, in ethaline having 50 mM SbCl₃ and heated to 60° C.), showing the sharp tin features at ˜31-33° 2θ fading in intensity from 0 s to 60 s immersion, while an overlapping SnSb/Sb peak arises at ˜28-29° 2θ and grows with time.

FIG. 3 illustrates cycling data for Sn thin films modified by galvanic displacement at different temperatures, with a deposition solution in ethaline having 50 mM SbCl₃, and where the films were submerged for 2 min.

FIG. 4 illustrates cycling data for Sn thin films modified by galvanic displacement at 60° C. for different amounts of time, with a deposition solution in ethaline having 50 mM SbCl₃.

FIG. 5 illustrates X-ray diffraction of Sn—Sb thin films prepared by galvanic displacement with different immersion times (0 s, pristine, to 30 min.) in an ethaline solution having 5 mM SbCl₃ and heated to 80° C.

FIG. 6 illustrates glancing angle X-ray diffraction patterns and refinement of SnSb film, where the film was formed in an ethaline solution having 5 mM SbCl₃ at 80° C. after 30 min., and Rwp is a weighted profile R-factor of the fit.

FIG. 7 Glancing angle X-ray diffraction and refinement of SnSb film. The film was formed in an ethaline solution having 50 mM SbCl₃ at 80° C. after 2 min., where Rwp is a weighted profile R-factor of the fit.

FIG. 8 illustrates XPS (X-Ray Photoelectron Spectroscopy) depth profiles of SnSb films formed by galvanic displacement in ethaline solutions having 5 mM and 50 mM Sb.

FIG. 9 illustrates cycle data for SnSb thin films prepared by galvanic displacement, where the 5 mM sample was prepared in an ethaline solution having 5 mM SbCl₃ at 80° C. and submerged more than 30 min., and the 50 mM sample was prepared in an ethaline solution having 50 mM SbCl₃ at 80° C. and submerged more than 2 min., for 90 cycles at a C/5 C rate.

FIG. 10 illustrates rate tests of SnSb thin films prepared by galvanic displacement, where the 5 mM sample was prepared in ethaline with 5 mM SbCl₃ at 80° C., and submerged for more than 30 min., while the 50 mM sample was prepared in an ethaline solution having 50 mM SbCl₃ at 80° C., and submerged for more than 2 min., for 90 cycles at a C/5 C rate.

FIG. 11 illustrates Scanning Electron Microscopy (SEM) scans of metal foams before and after galvanic displacement: (a) Sn electrodeposited on nickel foam with a high magnification image displaying homogeneous surface coverage; and (b) Sb reduced onto a tin film on a nickel foam.

FIG. 12 illustrates X-ray diffraction patterns of Cu₂Sb on Cu formed by galvanic displacement, where the Cu film was submerged in an ethaline solution having 50 mM SbCl₃ at 80° C., for 2 min.

FIG. 13 illustrates X-ray diffraction patterns of Cu₂Sb on Cu foam formed by galvanic displacement, where the Cu foam was submerged in an ethaline solution having 50 mM SbCl₃ for 0 min., 2 min., 5 min., and 10 min. at 80° C.

### DETAILED DESCRIPTION

As stated, achieving a homogeneous surface coverage on a 3D structure with electrodeposition during alloy deposition is difficult. However, single-element 3D electrodeposition has been accomplished in industrial settings for many years. Therefore, separately electrodepositing tin for generating homogeneous surface coverage followed by incorporating antimony into the electrodeposited film using another method, has been explored in embodiments of the present invention. Galvanic displacement is a method for reducing cations in solution by exposing the solution to a deposited less noble elemental metal, which is then displaced due to redox chemistry. It allows depositions on both 2D and 3D surfaces.

Galvanic displacement has been particularly effective in microelectronics and catalysis applications. For instance, in printed circuit board (PCB) manufacturing, issues arise from nickel oxidation, where long-term storage reduces the reliability of solder joints. One heavily researched solution is the Electroless Nickel Immersion Gold (ENIG) process, where a thin layer of gold is formed on the surface of nickel by galvanic displacement. Variations on this method include the displacement of Cu with Ag, or Sn. This method allows for the selective formation of homogeneous thin films on only the nickel surfaces, allowing for the immersion of a complete PCB. In catalysis, galvanic displacement has been used to modify the surface structure of electrodes to create thin, homogeneous films across porous structures. In these two cases, galvanic displacement incorporates a thin surface coating of a more noble metal on another metal surface.

Briefly, embodiments of the present invention include a method utilizing galvanic displacement to synthesize SnSb on 2D and 3D structures with control over morphology and composition, by incorporating Sb into a Sn-coated 2D film or 3D foam. The influence of reaction temperature, reaction time, and concentration of Sb influence the rate of Sb formation, on the propensity to form SnSb, and the resultant morphology using thin film substrates were investigated. Additionally, how changes in SnSb morphology influence the lifetimes and rate capabilities of films and foams synthesized by galvanic displacement were studied. These parameters were systematically assessed using thin films before pursuing foams.

Reference will now be made in detail to the present embodiments of the invention, examples of which are illustrated in the accompanying drawings. It will be understood that the FIGURES are presented for the purpose of describing particular embodiments of the invention and are not intended to limit the invention thereto.

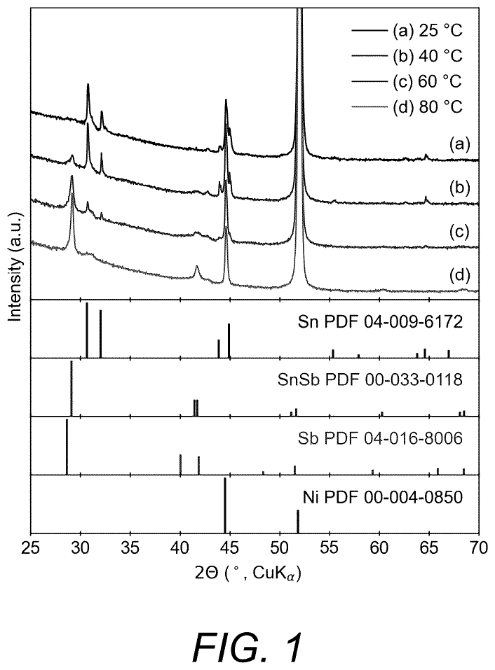

FIG. 1 shows X-Ray Diffraction (XRD) scans of SnSb films prepared by galvanic displacement at different temperatures (a) 25° C. (room temperature); (b) 40° C.; (c) 60° C.; and (d) 80° C. As the temperature was increased for the galvanic displacement process, more Sb was reduced on the surface of the anode. At higher temperatures, almost complete conversion to crystalline SnSb occurred, as observed by XRD. The phase diagram of SnₓSb has been extensively studied, and temperatures as high as 1000° C. have been used to achieve Sn/Sb diffusion. However, FIG. 1 clearly illustrates that SnSb formation occurs in ethaline at temperatures as low as 80° C. X-ray diffraction showed that SnSb formation also occurred at elevated temperatures, but Scanning Electron Microscopy (SEM) revealed little difference in the resultant morphology of the thin films after galvanic displacement.

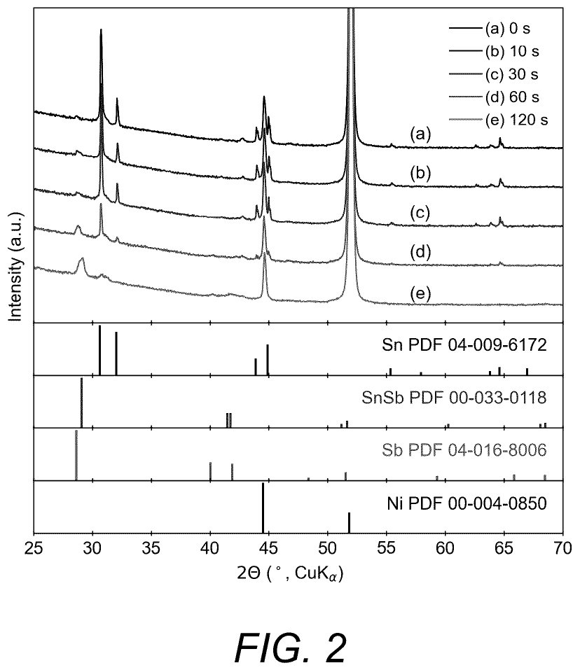

To further evaluate Sb incorporation at lower temperatures, galvanic displacement was performed at different timescales. FIG. 2 illustrates XRD results for galvanic displacement times of: (a) 0 s; (b) 10 s; (c) 30 s; (d) 60 s; and (e) 120 s at 60° C. It may be observed that between 10 s of immersion and 2 min. of immersion, an Sb phase is present that increases in intensity as immersion time increases. Investigation of these films by Scanning Electron Microscopy (SEM) and Energy Dispersive X-Ray Spectroscopy (EDS) identified distinct regions of stripped Sn and Sb growth along the Sn grains.

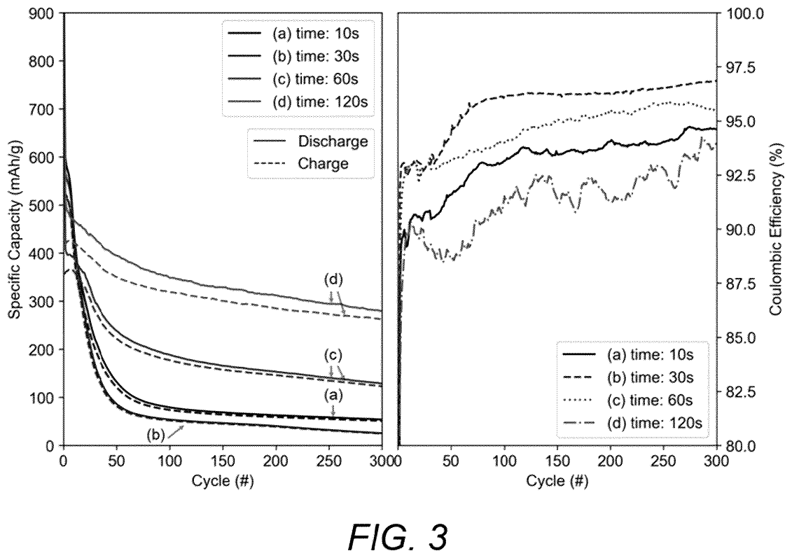

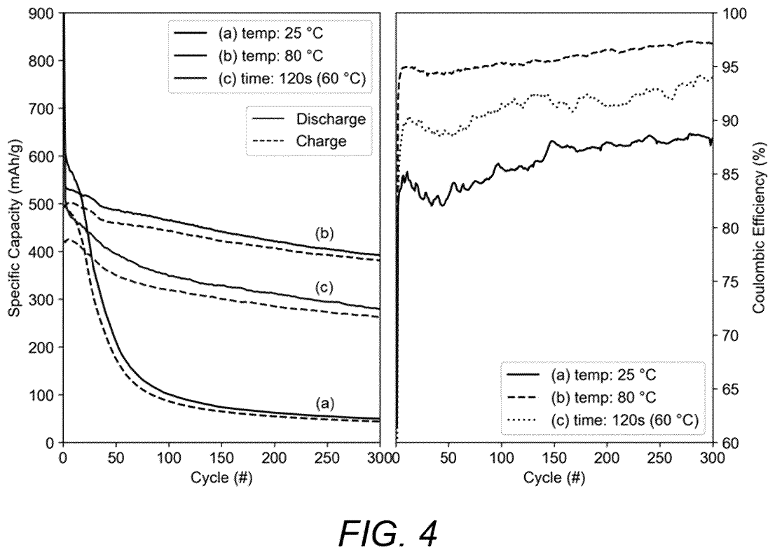

As illustrated in FIG. 3 and FIG. 4, films prepared using the previously mentioned times and temperatures, respectively, were cycled in Na-ion half-cells to investigate the relative differences in capacity retention. The film formed at 80° C. maintained the highest capacity after 300 cycles. Each of the films formed at 60° C. for the times utilized showed an increase in capacity retention for the films submerged for the longer times. Similarly, capacity retention increased as the temperature was increased. Summarizing, the films having increased Sb content, and therefore more galvanic displacement, exhibited increased capacity retention as both the time and temperature were increased.

One of the present inventors has found that Sb concentration influenced cycle performance; therefore, the increased Sb incorporation seen in the higher temperature samples may be the cause of the extended lifetime of the anodes formed at higher temperatures and longer times. However, an alternative hypothesis might be that increased porosity in the anode material reduces the effects of volume expansion during cycling. The marked capacity increase in the SnSb film formed at 80° C., was investigated further by the comparison of SnSb formed from a solution having 50 mM Sb with SnSb formed from a solution having 5 mM Sb.

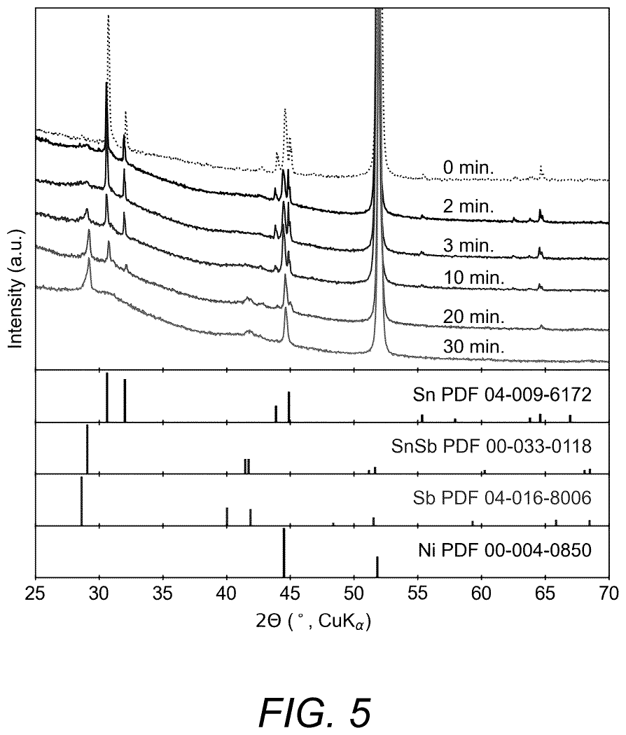

While temperature influenced the phases of Sn and Sb formed during the galvanic displacement process, the relative concentration of dissolved Sb in the ethaline electroless deposition solution was changed to achieve different crystalline morphology. Lowering the solution concentration of Sb from 50 mM to 5 mM resulted in a different timescale for SnSb formation; therefore, a range of immersion times between 2 min. and 30 min. were used to identify a reasonable timescale for SnSb formation. FIG. 5 illustrates that SnSb was produced with small amounts of excess Sb in 30 min. Decreasing the concentration of Sb and increasing the reaction time resulted in a more faceted, crystalline morphology compared to the rounded, bulbous morphology exhibited in the higher concentration sample.

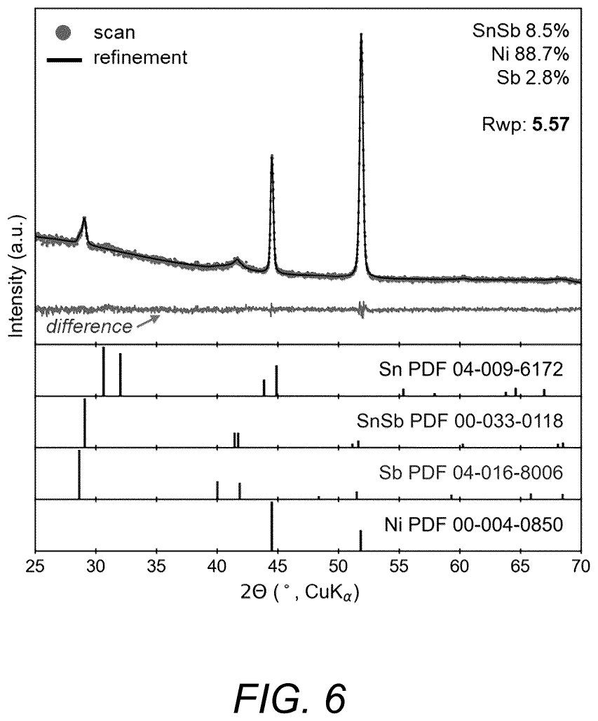

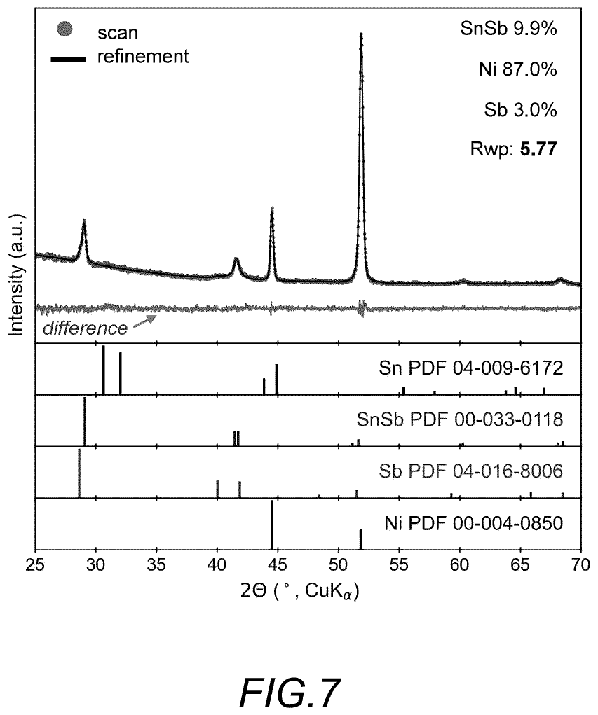

FIG. 6 and FIG. 7 illustrate that Rietveld refinements performed on the XRD patterns for SnSb thin films formed with 5 mM SbCl₃ for 30 min., and with 50 mM SbCl₃ for 2 min., both at 80° C., respectively, reveal similar phase distributions. Ni is the largest phase, as this is the bulk substrate. The second largest phase is SnSb, followed by a small Sb phase.

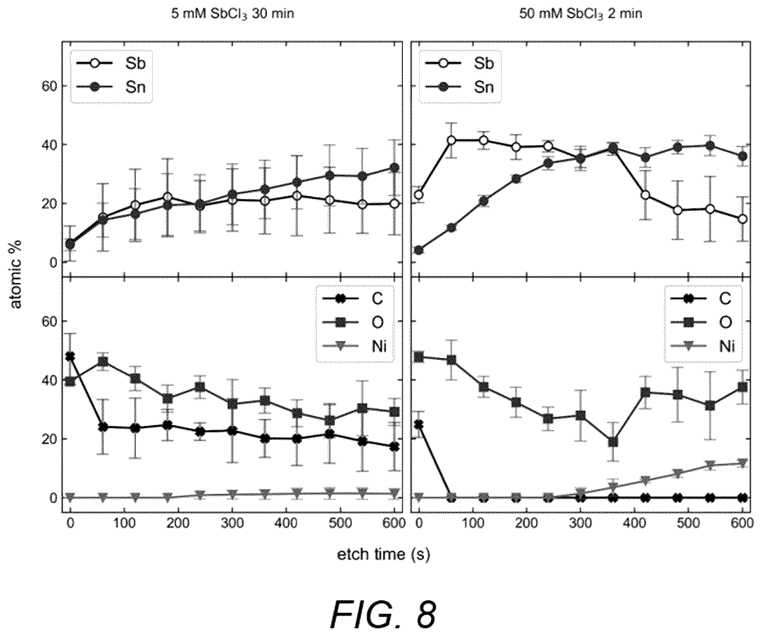

Another consequence of lowering the concentration of Sb in the ethaline solution was that Sb penetrated much deeper into the Sn, as seen with X-ray photoelectron spectroscopy (XPS) depth profiling in FIG. 8 (2 min. vs. 30 min. at 80° C.). The increased Sb diffusion may be attributable to the increased time the film was exposed to elevated temperatures.

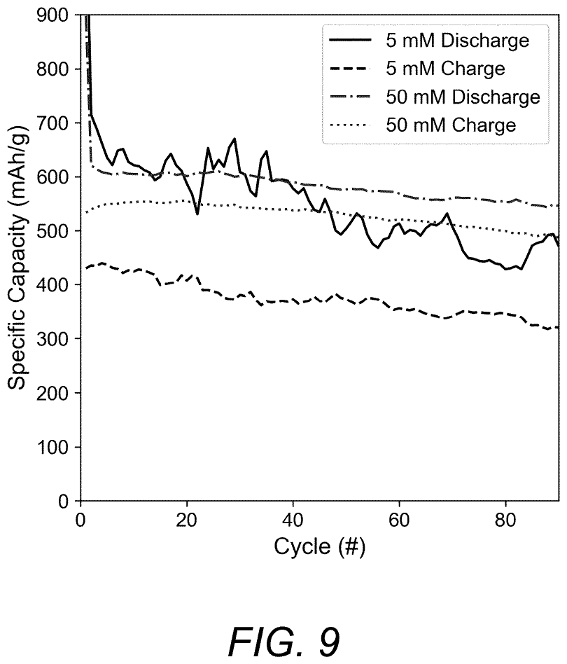

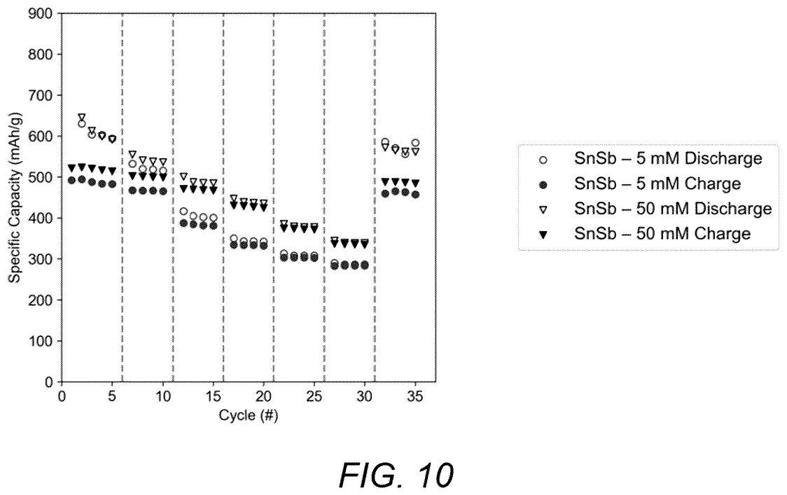

Both of the SnSb thin films, 5 mM SbCl₃ were cycled for 30 min., and 50 mM SbCl₃ for 2 min., to compare their ability to hold capacity over time. As illustrated in FIG. 9, the high concentration sample was found to generally maintain charge and discharge capacities over 90 cycles, while the low concentration sample displayed significant changes in discharge capacity and a substantially lower charge capacity. FIG. 10 illustrates the measurement of the rate capabilities of these materials. The cells were cycled between a C/10 C-rate (completely charging over 10 h, completely discharging over 10 h) and a 4 C C-rate (completely charging over 15 min., and completely discharging over 15 minutes). At 4 C, the low concentration sample delivered a discharge capacity of 286 mAh/g for 4 cycles, while the higher concentration sample delivered a discharge capacity of 347 mAh/g for 4 cycles.

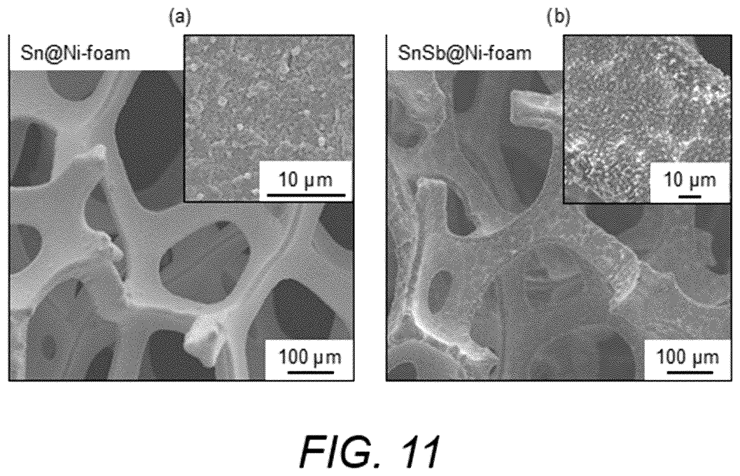

FIG. 11a illustrates homogeneous coverage of Sn on a 3D Ni foam electrode using the galvanic displacement procedure utilized for 2D films, with 50 mM Sb at 80° C., while FIG. 11b illustrates the homogeneous coverage for SnSb. The nickel foam had a porosity: 295% (80-110 Pores per in. with an average hole diameter of about 0.25 mm), and a thickness of 1.6 mm. It is expected that similar results will be obtained for nickel foams having between 92% and 98% porosity, with pore diameters between about 0.1 mm and 6 mm pores depending on supplier, with a thickness between 0.5 mm and 1.6 mm.

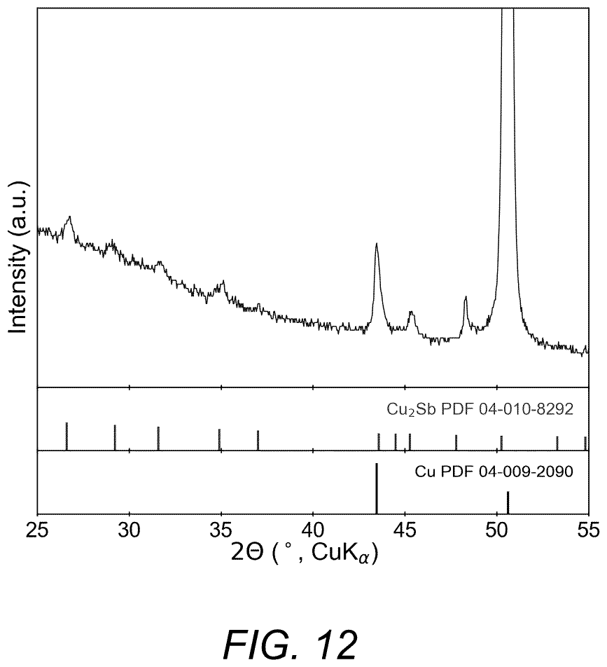

The galvanic synthesis method utilized for depositing SnSb on nickel films and foams, was used to form Cu₂Sb on Cu films and Cu foam. The Cu alloyed with Sb to form Cu₂Sb, making an initial electrodeposition thin film formation step unnecessary. FIG. 12 illustrates an XRD scan of a homogeneous thin film of Cu₂Sb generated after 2 min. of submerging a Cu film into ethaline having 50 mM SbCl₃ at 80° C.

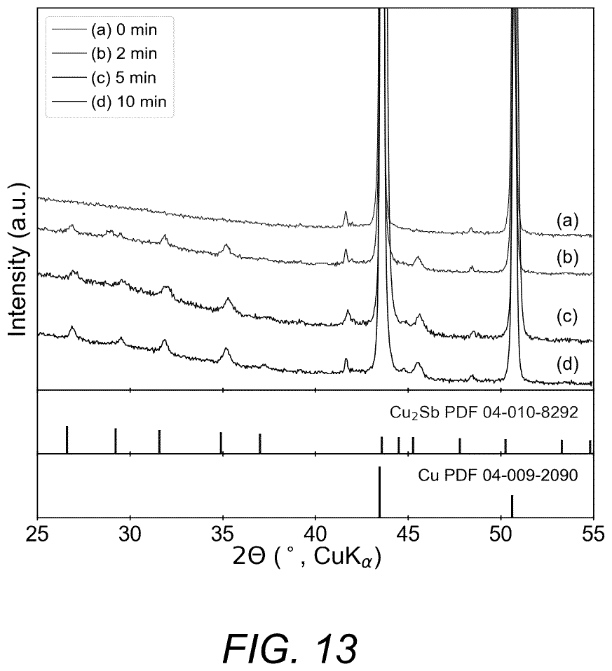

Similarly, Cu₂Sb was formed on Cu foam after 2 min. with the same synthesis parameters used for the Cu film. Immersing the foams for longer (up to 10 min.) resulted in similar X-ray diffraction patterns, as illustrated in FIG. 13. SEM investigation of the Cu₂Sb deposited on Cu foam revealed homogeneous coverage from the edges of the foam to the center.

### Characterization:

The morphology of electrodeposited films was analyzed by Scanning Electron Microscopy (SEM) using a JEOL JSM-6500F Microscope at 15 kV, and Energy Dispersive X-ray Spectroscopy (EDS) with an Oxford instrument X-Max and Aztec Software. Crystalline phases were identified via Powder X-ray Diffraction (PXRD) using a Bruker D8 Discover DaVinci powder X-ray Diffractometer using Cu Kα radiation, with a 0.2 mm slit opening. X-ray Photoelectron Spectroscopy was performed with a Physical Electronics (PHI) 5800 series Multi-Technique ESCA system with a monochromatic Al Kα (hν=1486.6 eV) X-ray source operating at 350.0 W.

Having generally described embodiments of the invention, the following EXAMPLES demonstrate further aspects thereof.

### Example 1

### Synthesis of Ethaline Deposition Solutions:

All glassware used in synthesis was oven-dried overnight. Choline chloride (Acros Organics, 99%) was recrystallized in absolute ethanol, vacuum filtered, then left in a vacuum oven overnight at 110° C. Water was distilled from ethylene glycol (Fisher Scientific, 99.8%) in a distillation apparatus. Ethylene glycol and choline chloride were then combined in a 2:1 molar ratio, respectively. The solution was mixed at 80° C. for between 3 h and 6 h while vigorously stirring, forming ethaline. Other solvents may include: ionic liquids, dimethyl sulfoxide, tetrahydrofuran, carbonates, acetates, acetone, ethanol, isopropanol, acetonitrile, and other deep eutectic solvents than ethaline. For electrodeposition solutions, tin (II) chloride dihydrate (SnCl₂*2H₂O, Sigma Aldrich, 98%, 50 mM) was added to the ethaline solution and heated at 80° C. while vigorously stirring for between 20 min. and 30 min. (until mostly dissolved), then sonicated for 5 min. to ensure dissolution. For the galvanic displacement synthesis, antimony (III) chloride (SbCl₃, Sigma Aldrich, ≥99.0%) was dissolved in ethaline in an identical fashion to the Sn dissolution procedure above. Solutions were used within one week of preparation and stored in a sealed container.

### Example 2

### Sn Film Electrodeposition on Ni Substrates:

All electrochemical measurements of ethaline deposition solutions were performed using a Gamry Reference 3000 Potentiostat, and analyzed using Gamry Analyst software. A water-circulating jacket beaker was used to bring the ethaline solution to 80° C. Cyclic Voltammetry (CV) was performed using a three-electrode apparatus, with a platinum working electrode and platinum mesh counter electrode. Scans were conducted at 50 mV/s, beginning at 0 V vs. Fe(CN)₆^{3-/4-}, and proceeded to −1.25 V for the initial sweep, followed by a positive sweep to 1 V and a final sweep to return to 0 V.

The reference electrode was homemade, using a 2.5 mM potassium ferricyanide (K₃Fe(CN)₆, Fisher Scientific, 98%) combined with 2.5 mM potassium hexacyanoferrate (II) trihydrate (K₄Fe(CN)₆*3H₂O, Oakwood chemical, 98%) and dissolved in ethaline. A platinum mesh was used as the counter electrode. Electrodepositions were performed using a single-step chronocoulometric scan for 256.7 mC/cm² at −0.9V vs. Fe(CN)₆^{3-/4-} on a nickel substrate with an area of 3.00 cm² at 80° C. for 60 s. The resulting electrodeposition made Sn thin films with 0.1579 mg/cm² (or 0.2 mg per ½ inch circle, the size of the active material for half-cells). A ½″ stir bar was placed at the bottom of the 50 mL heating jacket for stirred electrodepositions.

The chronocoulometric scan may be between 150 mC/cm² and 1000 mC/cm²; the voltage may be between −0.7 V and −1.25 V; the temperature may be between 80° C. and 100° C.; and the electrodeposition time may be between 1 min. and 10 min.

After the films were deposited, they were immediately removed from the electrodeposition solution and thoroughly rinsed with ethanol, then water, and again with ethanol. Once dried, the films were dipped into the Sb solution with a chosen range of temperatures achieved using the jacket heater. The resulting films were rinsed with ethanol, then water, and again with ethanol. The above rinsing and drying steps are expected to improve the resulting films.

### Example 3

### Sn Electrodeposition on Ni Foams:

An aqueous electrodeposition solution having 0.075 M HCl, 0.05 M Sodium Citrate, and 0.018 M SnCl₂*2H₂O was prepared. The components were gently stirred until no solids were present, and the stirring stopped. The solution was permitted to rest 1 day before using.

Ni Foam (1 cm×4 cm having a porosity: ≥95% (80-110 Pores per in. with an average hole diameter of about 0.25 mm), and a thickness of 1.6 mm)) was sonicated in isopropyl alcohol (IPA) for 3 min., then rinsed with IPA and ethanol. A gentle stream of air was used to quickly dry the foam before sonicating in 5 M HCL for 3 min. The foam was then rinsed with water and IPA, and again dried under a gentle stream of air. The edges of the foam were coated with nail polish prior to electrodeposition. A stainless-steel mesh counter electrode (cleaned with acetone, after which the edges were coated with nail polish, approximately 2 in.×3 in.) was used for the electrodeposition. The foam was potentiostatically cycled using repeating chronoamperometry starting with a negative potential segment of with between −0.8 V vs. Saturated Calomel Electrode (SCE) (0.09 s), and a more positive potential segment of −0.3 V vs. SCE (0.01 s), where the current is momentarily inverted. The repeating chronoamperometry scan was cycled between the negative potential segment and the more positive potential segment for 10 min.

The more negative potential segment in the repeating chronoamperometry scan may be between −1.25 V vs. SCE and −0.7 V vs. SCE, and the time for the more negative step may be between 0.07 s and 0.095 s. The more positive potential segment may be between −0.5 V vs. SCE and 0.3 V vs. SCE, and the time for the more positive potential segment may be between 0.005 s and 0.03 s. The electrodeposition time may be between 10 min. and 60 min.

Once the electrodeposition was complete, the foam was removed from the solution and rinsed thoroughly with water, then ethanol. The foam was then gently dried under a stream of air, then rinsed with acetone to remove excess nail polish prior to the next step. After the foam was rinsed with acetone, it was dried again under a stream of air. The foam was then submerged in ethaline with 50 mM SbCl₃ for 2 min. at 80° C. After submerging, the foam was rinsed with ethanol, then water, and again with ethanol. As stated above, the rinsing and drying steps are expected to improve the resulting films.

Cyclic voltammetry (CV) was performed, before beginning electrodeposition. A Pt working electrode (0.2 mm), SCE reference electrode, and a stainless-steel mesh counter electrode (cleaned with acetone, after which edges were coated with nail polish, approximately 2 in.×3 in.) were used to carry out the cyclic voltammetry. Cyclic voltammetry was carried out prior to each electrodeposition at a 50 mV/s scan rate. Each CV started at Open Circuit Potential (OCP), scanned negatively to −1.25 V vs. SCE, then positively to 1 V vs. SCE, for 3 cycles before ending at OCP.

### Example 4

### Cu₂Sb Formation on Cu Films

Copper films (1 cm×3 cm) were sonicated in isopropanol for 30 s, then rinsed with ethanol. Immediately after drying, the films were washed with concentrated phosphoric acid for 30 s, then thoroughly rinsed with water followed by isopropanol.

An ethaline solution having 50 mM SbCl₃ was heated to 80° C. using a glass jacket heater equipped with a water circulator heater. The prepared Cu film was dipped in the ethaline solution for 2 min., then removed and rinsed with water and subsequently isopropanol.

### Example 5

### Formation of Cu₂Sb on Cu Foam:

Copper foam (1 cm×4 cm) was sonicated in isopropanol for 3 min., then rinsed with ethanol. The rinsed Cu foam was then dried under a gentle stream of air. Once dried, the foam was sonicated in concentrated phosphoric acid for 1 min., then rinsed with water and then with ethanol. The foam was then again dried with a gentle stream of air.

The foam was then submerged in ethaline solution having 50 mM SbCl₃ at 80° C. for times between 2 min. and 10 min. The resulting foams were then rinsed with water and subsequently with ethanol, and air-dried. Scanning electron microscopy images show Cu₂Sb homogeneously forming on the surface from the edges to the center and throughout the foam.

### Example 6

### Half-Cell Assembly and Galvanostatic Cycling:

All electrolyte preparation and half-cells were assembled in an argon glovebox (<1 ppm O₂) using a two-electrode Swagelok apparatus. Each electrodeposited tin thin film was cut into a ½″ diameter circle as the active material, and the initial mass of Sn was calculated using Faraday's law of electrolysis to calculate deposition mass. The ratio of Sn to Sb in SnSb produced by Galvanic displacement was calculated from XRD and verified with XRD. The theoretical capacity was calculated by calculating the amount of Sn etched and Sb deposited, assuming that the conversion was 2 Sb atoms per 3 Sn atoms, according to the following reaction:

$$3 Sn ( 0 ) + 2 Sb ( III ) \to 3 Sn ( II ) + 2 Sb ( 0 )$$

The cut thin film was then used as the working electrode, followed by a polypropylene separator (MTI Corp), then a Whatman glass filter paper, and another polypropylene separator. After this, about 20 μL of electrolyte was added, followed by a ½″ punch of sodium metal polished with dry hexanes before use. The electrolyte consisted of a 1M solution of sodium perchlorate (NaClO₄, Sigma-Aldrich, ≥98% ACS reagent) in propylene carbonate (PC, Sigma Aldrich, 99.7%) with a 5% by volume of fluoroethylene carbonate (FEC, Sigma-Aldrich, 99%). Cells were allowed to rest for 12 h before galvanostatic cycling with an Arbin battery tester between 0.005 V and 1.5 V vs. Na/Nat at a C/2 rate at room temperature (25° C.). C-rate was assigned based on the theoretical capacity of each anode.

The foregoing description of the invention has been presented for purposes of illustration and description and is not intended to be exhaustive or to limit the invention to the precise form disclosed, and obviously many modifications and variations are possible in light of the above teaching. The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A method for forming a 2-dimensional film of SnSb, comprising:
preparing a solution having a chosen concentration of tin (II) chloride dihydrate in ethaline;
electrodepositing a film of tin from the tin (II) chloride dihydrate solution onto a metal substrate;
preparing a second solution having a chosen concentration of antimony (III) chloride in ethaline; and
exposing the electrodeposited film to the second solution for a chosen time and at a selected temperature;
whereby electrodeposited tin in the film is replaced by antimony by galvanic displacement, thereby generating a chosen quantity of SnSb on the film.

2. The method of claim 1, further including the steps of rinsing the electrodeposited film with a solvent and with water; and drying the rinsed electrodeposited film after said step of electrodepositing the film of tin.

3. The method of claim 1, wherein the metal substrate is chosen from nickel and copper metal substrates.

4. The method of claim 1, wherein said step of electrodepositing a film of tin is performed using a single-step chronocoulometry scan between 150 mC/cm² and 1000 mC/cm² between −0.7 V and −1.25 V vs. Fe(CN)₆^{3/-4-}, at between 80° C. and 100° C. for between 60 s and 600 s.

5. The method of claim 4, wherein said step of electrodepositing a film of tin is performed using a single-step chronocoulometry scan for 256.7 mC/cm² at −0.9 V vs. Fe(CN)₆^{3-/4-}, at 80° C. for 60 s.

6. The method of claim 1, wherein said step of exposing the electrodeposited film to the second solution is undertaken for a chosen time between 10 s and 120 s, and at a selected temperature between 25° C. and 100° C.

7. The method of claim 1, wherein said generated 2-dimensional film of SnSb is utilized as a battery anode.

8. The method of claim 7, wherein said generated 2-dimensional film of SnSb is used as the battery anode for alkali-ion batteries.

9. A method for forming a 3-dimensional film of SnSb, comprising:
preparing an aqueous solution having a chosen concentration of tin (II) chloride dihydrate, HCl, and Sodium Citrate;
electrodepositing a film of tin from the aqueous solution of tin (II) chloride dihydrate, HCl and Sodium Citrate onto a 3-dimensional metal substrate for a chosen time at a selected voltage range;
preparing a second solution of having a chosen concentration of antimony (III) chloride in ethaline; and
exposing the 3-dimensional metal substrate to the second solution for a second chosen time and at a second chosen temperature;
whereby electrodeposited tin on the 3-dimensional metal substrate is replaced by antimony by galvanic displacement, thereby generating a chosen quantity of SnSb on the 3-dimensional metal substrate.

10. The method of claim 9, further including the steps of rinsing the 3-dimensional metal substrate onto which the film of tin has been electrodeposited with solvents, acid, and water; and drying the 3-dimensional metal substrate after said step of rinsing.

11. The method of claim 9, wherein the 3-dimensional metal substrate is chosen from foams, nanowire arrays, electrospun carbon fiber meshes, and interdigitated electrodes.

12. The method of claim 9, wherein the 3-dimensional metal substrate is chosen from nickel and copper 3-dimensional metal substrates.

13. The method of claim 9, wherein said step of electrodepositing a film of tin is performed by potentiometrically cycling the 3-dimensional metal substrate between −0.8 V vs. SCE for between 0.07 s and 0.09 s, and −0.3 V vs. SCE for between 0.005 s and 0.03 s for a chosen time between 5 min. and 60 min.

14. The method of claim 9, wherein said step of exposing the 3-dimensional metal substrate to the second solution is undertaken using a 50 mM solution of SbCl₃ in ethaline for a second chosen time of 2 min. at a second chosen temperature of 80° C.

15. The method of claim 9, wherein said generated 3-dimensional film of SnSb is utilized as a battery anode.

16. The method of claim 15, wherein said generated 3-dimensional film of SnSb is used as the battery anode for alkali-ion batteries.

17. A method for forming a 2-dimensional film of SnSb, comprising:
preparing a solution having a chosen concentration of tin (II) chloride dihydrate in a first nonaqueous solvent;
electrodepositing a film of tin from the tin (II) chloride dihydrate solution onto a metal substrate;
preparing a second solution having a chosen concentration of antimony (III) chloride in a second nonaqueous solvent; and
exposing the electrodeposited film to the second solution for a chosen time and at a selected temperature;
whereby electrodeposited tin in the film is replaced by antimony by galvanic displacement, thereby generating a chosen quantity of SnSb on the film.

18. The method of claim 17, wherein the first nonaqueous solvent and the second nonaqueous solvent are chosen from ionic liquids, dimethyl sulfoxide, tetrahydrofuran, carbonates, acetates, acetone, ethanol, isopropanol, acetonitrile, deep eutectic solvents, and ethaline.

19. The method of claim 17, wherein the metal substrate is chosen from nickel and copper.

20. The method of claim 17, wherein the selected temperature is 80° C.

21. A method for forming Cu₂Sb on a copper film, comprising:
preparing a solution of SbCl₃ in ethaline at 80° C.; and
submersing the copper film in the solution for a chosen period.

22. The method of claim 21, wherein the chosen period is 120 s.

23. The method of claim 21, wherein the solution of SbCl₃ is 50 mM SbCl₃ in ethaline.

24. The method of claim 21, further comprising the steps of washing the copper film with concentrated phosphoric acid; rinsing with water; and then rinsing with isopropanol, before the copper film is submersed in the solution.

25. A method for forming Cu₂Sb on copper foam, comprising:
preparing a solution of SbCl₃ in ethaline at 80° C.; and
submersing the copper foam in the solution for a chosen period.

26. The method of claim 25, wherein the chosen period is between 120 s and 600 s.

27. The method of claim 25, wherein the solution of SbCl₃ is 50 mM SbCl₃ in ethaline.

28. The method of claim 25, further including the steps of washing the copper foam with concentrated phosphoric acid; rinsing with water; and then rinsing with ethanol, before said copper foam is submersed in the solution.
